(19) United States
(12) Patent Application Publication
(10) Pub. No.: US 2012/0027365 A1
(43) Pub. Date: Feb. 2, 2012

(54) OPTICAL COMMUNICATION DEVICE AND METHOD OF ASSEMBLING THE SAME

(76) Inventors: Keiichi Tatsuta, Niigata-ken (JP); Toshihiro KIKUCHI, Niigata-ken (JP); Katsushi NAGAYAMA, Niigata-ken (JP); Kenichi SUKURAI, Niigata-ken (JP); Masaru WATANABE, Niigata-ken (JP); Yoshikatsu IKEDA, Niigata-ken (JP)

(21) Appl. No.: 13/189,078

(22) Filed: Jul. 22, 2011

(30) Foreign Application Priority Data
Jul. 27, 2010 (JP) 2010-167850

(51) Int. Cl. G02B 6/36; B23P 11/00

(52) U.S. Cl. 385/92; 29/428

(57) ABSTRACT

A light receiving holder includes an abutting portion and a welded portion and the welded portion includes a ring-shaped projection which extends from the welded portion and whose cross-section is smaller as it is closer to the tip of the projection. A cap of a casing constituting a light receiving unit is received in a through-hole of the light receiving holder. The projection is brought into contact with a flange of the casing. Current is supplied between a lower electrode and an upper electrode to resistance-weld the projection to the flange. At this time, an angle is provided between a facing face of the lower electrode and a facing face of the upper electrode so that the light receiving holder is welded to the light receiving unit while an angle of the light receiving unit relative to the light receiving holder is adjusted.

### CLAIM OF PRIORITY

This application claims benefit of Japanese Patent Application No. 2010-167850 filed on Jul. 27, 2010, which is hereby incorporated by reference in its entirety.

### BACKGROUND

1. Field of the Disclosure

The present disclosure relates to an optical communication device in which a light receiving unit, including a casing and a light receiving element received in the casing, is position-adjusted and attached to a housing and light traveling along an optical path, such as an optical fiber, is received by the light receiving element, and relates to a method of assembling the same.

2. Description of the Related Art

In an optical communication device including a light receiving element, a light receiving unit including a casing and the light receiving element received in the casing is attached to a housing, an optical fiber serving as an optical path is mounted on the housing, and the optical fiber applies light to the light receiving element.

Japanese Unexamined Patent Application Publication No. 9-211258 discloses an optical communication module in which an opening is formed in a housing mounted with an optical fiber and a casing supporting a light receiving element is fitted and attached to the opening. Japanese Unexamined Patent Application Publication No. 2005-164971 discloses an optical module in which a holding member is attached to a side surface of a housing, the holding member has a through-hole, and a casing supporting a light receiving element is fitted and secured to the through-hole.

In such an optical communication device, the casing supporting the light receiving element has to be positioned relative to the housing and be secured thereto such that the optical axis of light applied from the optical path including the optical fiber coincides with the light receiving element as much as possible.

Since the optical communication module disclosed in Japanese Unexamined Patent Application Publication No. 9-211258 has a structure in which the casing supporting the light receiving element is fitted and secured to the opening in the housing, the casing can be moved in a direction intersecting the center line of the casing to adjust the light receiving element such that the light receiving element coincides with the optical axis of light transmitted through the optical fiber. It is, however, difficult to perform adjustment for moving the light receiving element in a direction along the optical axis and adjustment for changing an angle at which the optical axis faces the light receiving element.

In the optical module disclosed in Japanese Unexamined Patent Application Publication No. 2005-164971, when the holding member attached to the side surface of the housing is moved in a direction orthogonal to the optical axis, the position of the light receiving element can be adjusted in the direction intersecting the optical axis. It is, however, difficult to adjust the position of the light receiving element in the direction along the optical axis and an angle of inclination (hereinafter, “inclination angle”) of the light receiving element relative to the optical axis.

In the optical module disclosed in Japanese Unexamined Patent Application Publication No. 2005-164971, in order to adjust the position of the light receiving element in the direction along the optical axis or an angle by which the light receiving element is inclined relative to the optical axis, a plurality of holding members having different thicknesses or a plurality of holding members having through-holes at different angles have to be provided, an optimum holding member has to be selected from among them, and after that, assembly is done. Disadvantageously, the provision of the holding members having different thicknesses or the holding members having the through-holes at different angles results in an increase in manufacturing cost. Management of the holding members is complicated and an operation of selecting any of the holding members and attaching the selected member is also complicated. Disadvantageously, the number of steps of adjusting the attachment position of the light receiving element is increased.

### SUMMARY

An optical communication device includes a metal housing, a casing having a metal flange, a light receiving element supported by the casing, a metal holder that fixes the casing to the housing, and an optical path that guides light to the light receiving element. The holder has a through-hole, an abutting portion surrounding one open end of the through-hole, and a welded portion surrounding the other open end of the through-hole, the welded portion including a projection whose cross-sectional area is smaller as the corresponding cross-section is closer to the tip of the projection. The holder and the flange are welded to each other through the partly melted projection pressed against the flange such that unmelted part of the projection adjusts an inclination angle of the abutting portion of the holder relative to the center line of the casing. The holder is fixed to the housing such that the abutting portion is in contact with the housing and an angle at which the light receiving element faces the optical path is determined on the basis of the inclination angle.

Another aspect provides a method of assembling an optical communication device including a metal housing, a casing having a metal flange, a light receiving element supported by the casing, a metal holder that fixes the casing to the housing, and an optical path that guides light to the light receiving element, the holder having a through-hole, an abutting portion surrounding one open end of the through-hole, and a welded portion surrounding the other open end of the through-hole, the welded portion including a projection whose cross-sectional area is smaller as the corresponding cross-section is closer to the tip of the projection. The method includes the steps of (a) while pressing the projection against the flange, supplying current to the holder and the flange to melt the projection in order to weld the holder to the flange, (b) adjusting an inclination angle of the holder relative to the flange during welding, and (c) bringing the abutting portion into contact with the housing to fix the holder to the housing such that an angle at which the light receiving element faces the optical path is set on the basis of the inclination angle.

### BRIEF DESCRIPTION OF THE DRAWINGS

FIG. 1 is a cross-sectional view of a optical communication device according to an embodiment of the present invention;

FIG. 2 is a diagram explaining an operation of adjusting a light receiving element to be attached to a housing;

FIG. 3A is a sectional view of a holder;

FIG. 3B is an enlarged sectional view of part of the holder;

FIG. 4 is a diagram explaining an operation of welding the holder to a flange;

FIG. 5 is a sectional view of the holder welded to the flange; and

FIG. 6 is a graph illustrating the relationship between coupling efficiency and an angle deviation between an optical path and the light receiving element.

### DESCRIPTION OF THE EXEMPLARY EMBODIMENTS

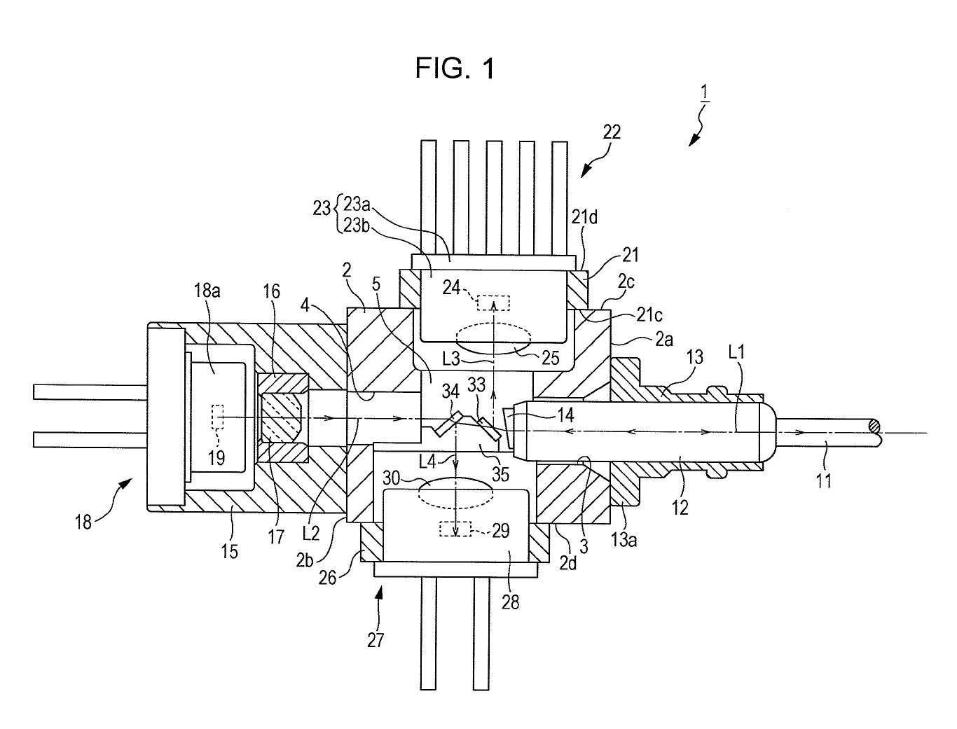

FIG. 1 illustrates an optical communication device 1 according to an embodiment of the present invention. The optical communication device 1 includes a housing 2 made of metal, such as ferritic stainless steel. The housing 2 has a fiber attachment face 2a, serving as an outer face on the right side in FIG. 1. The housing 2 further has a fiber mounting hole 3 which inwardly extends from the fiber attachment face 2a.

One end of an optical fiber 11 is held by a ferrule 12. The ferrule 12 is held by a ferrule holder 13 made of ferritic stainless steel. While one end of the ferrule 12 is fitted in the fiber mounting hole 3, a flange 13a of the ferrule holder 13 is in tight contact with the fiber attachment face 2a. The ferrule holder 13 is secured to the housing 2 by, for example, laser welding.

The one end, which is beveled and indicated by 14, of the optical fiber 11 extending from one end of the ferrule 12 is exposed in an internal space 5 of the housing 2. An optical path L1 passing through the center of the optical fiber 11 is slightly bent by passing the beveled end face of the optical fiber 11 and then enters the internal space 5.

The housing 2 further has a light-emission attachment face 2b, serving as an outer face on the left side in FIG. 1, and an optical-path hole 4 which inwardly extends from the light-emission attachment face 2b.

A light-emission holder 15 is attached to the light-emission attachment face 2b. The light-emission holder 15 is made of metal, such as ferritic stainless steel. A lens barrel 16 holding a converging lens 17 is secured inside the light-emission holder 15. The light-emission holder 15 holds a light emitting unit 18. The light emitting unit 18 includes a casing 18a made of metal, such as ferritic stainless steel, and a light emitting element 19, such as a laser diode, supported in the casing 18a.

Adjustment is performed such that the light-emission holder 15 is moved in a direction orthogonal to a light emission axis L2 while being in contact with the light-emission attachment face 2b of the housing 2, thus allowing the light emission axis L2 to coincide with the optical path L1. After the adjustment, the light-emission holder 15 is secured to the housing 2 by, for example, laser welding.

The housing 2 has a first light-receiving attachment face 2c, serving as the upper face thereof in FIG. 1, and a second light-receiving attachment face 2d, serving as the lower face thereof in FIG. 1. A first light receiving holder 21 is fixed to the first light-receiving attachment face 2c. The first light receiving holder 21 is made of metal, such as ferritic stainless steel. A first light receiving unit 22 is fastened to the first light receiving holder 21. The first light receiving unit 22 includes a casing 23 made of metal, such as ferritic stainless steel, a light receiving element 24, such as a PIN photodiode, and a light receiving lens 25 such that the light receiving element 24 and the light receiving lens 25 are held in the casing 23.

The first light receiving holder 21 is fixed to the casing 23 by welding. The first light receiving holder 21 is fixed to the housing 2 by welding such that the first light receiving holder 21 is in tight contact with the first light-receiving attachment face 2c.

A second light receiving holder 26 is firmly attached to the second light-receiving attachment face 2d. The second light receiving holder 26 is made of metal, such as ferritic stainless steel. A second light receiving unit 27 is fixed to the second light receiving holder 26. The second light receiving unit 27 includes a casing 28 made of metal, such as ferritic stainless steel, a light receiving element 29, such as a PIN photodiode, and a light receiving lens 30 such that the light receiving element 29 and the light receiving lens 30 are held in the casing 28.

The second light receiving holder 26 is fixed to the casing 28 by welding. The second light receiving holder 26 is fixed to the housing 2 by welding such that the holder is in tight contact with the second light-receiving attachment face 2d.

Two wavelength separation filters 33 and 34 are arranged in the internal space 5 of the housing 2. The two wavelength separation filters 33 and 34 are fixed to a support 35 disposed in the internal space 5.

To transmit data in the optical communication device 1, laser light emitted from the light emitting element 19 of the light emitting unit 18 is modulated based on transmission data and is then transmitted into the optical fiber 11.

The optical communication device 1 is capable of receiving wavelength division multiplexed laser light. A light component in a first waveband transmitted through the optical fiber 11 is separated by the first wavelength separation filter 33. The separated light component travels along a first optical path branch L3 and is then received by the light receiving element 24 of the first light receiving unit 22. After that, a received signal is demodulated. A light component in a second waveband transmitted through the optical fiber 11 is separated by the second wavelength separation filer 34. The separated light component travels along a second optical path branch L4 and is then received by the light receiving element 29 of the second light receiving unit 27. After that, a received signal is demodulated.

In the optical communication device 1 illustrated in FIG. 1, data transmitted as a light component separated by the first wavelength separation filter 33 is image data and data transmitted as a light component separated by the second wavelength separation filer 34 is communication data other than the image data.

When the first light receiving unit 22 is attached to the housing 2, it is necessary to perform adjustment such that the light receiving element 24 is positioned on the center line of the first optical path branch L3. Similarly, when the second light receiving unit 27 is attached to the housing 2, it is necessary to perform adjustment such that the light receiving element 29 is positioned on the center line of the second optical path branch L4. In addition, it is necessary to change the fixed position of the first light receiving unit 22 in the vertical direction in FIG. 1 in order to adjust the positions of the light receiving element 24 and the light receiving lens 25 on the first optical path branch L3 so that received light is focused on the light receiving element 24 to form an image. The same applies to attachment of the second light receiving unit 27.

Since a signal transmitted as a light component received through the first light receiving unit 22 is image data, the density and transmission rate of data to modulate light are high. In addition to positioning the light receiving element 24 of the first light receiving unit 22 on the center line of the first optical path branch L3, therefore, it is necessary to adjust an angle at which the first light receiving unit 22 faces the first optical path branch L3.

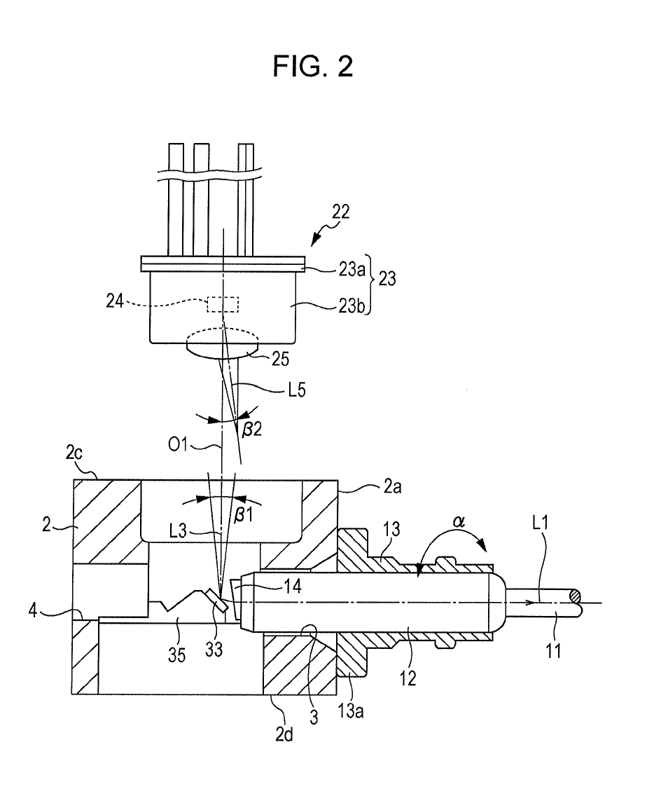

Referring to FIG. 2, a tolerance in a rotation direction (a direction) in which the ferrule 12 holding the optical fiber 11 is rotated during attachment, the accuracy of dimension of the support 35, a tolerance of attachment of the first wavelength separation filter 33 relative to the support 35, and the like are accumulated to cause a tolerance of an inclination angle β1 relative to the center line of the first optical path branch L3. On the other hand, in the first light receiving unit 22, for example, a tolerance of an attachment position of the light receiving element 24 and a tolerance of attachment of the light receiving lens 25 in the casing 23 cause an angle tolerance β2 between an optimum optical axis L5 for light receiving through the light receiving element 24 and the center line O1 of the casing 23.

Accordingly, when the first light receiving unit 22 is attached to the housing 2, an angle deviation up to β1+β2 occurs between the light-receiving optical axis L5 for the light receiving element 24 and the first optical path branch L3.

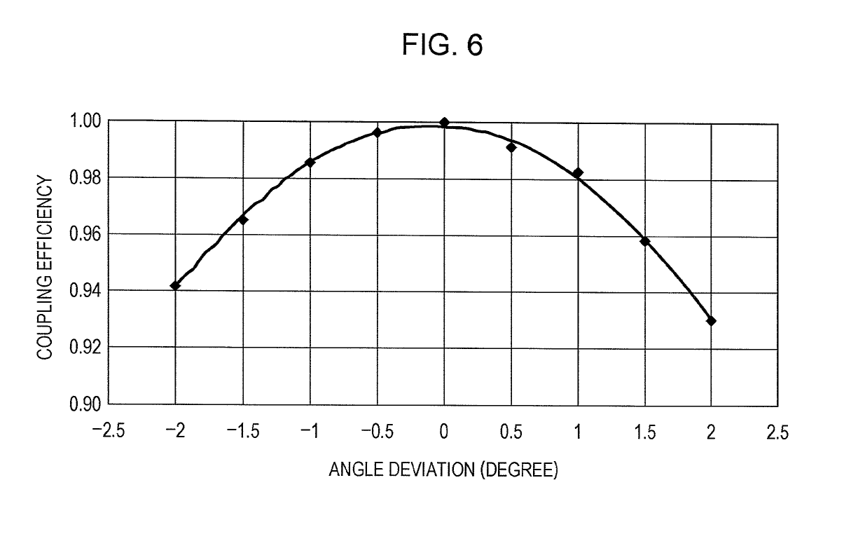

FIG. 6 illustrates coupling efficiency plotted against the angle deviation. When “1” indicates the power of light received by the light receiving element 24 of the first light receiving unit 22 when the angle deviation is zero, the coupling efficiency is the ratio of received light power upon occurrence of an angle deviation to received light power of “1”. Referring to FIG. 6, when an angle deviation of two degrees occurs, the coupling efficiency falls to about 93%.

When the first light receiving unit 22 for detecting light modulated based on image data is attached to the housing 2, therefore, the inclination of the first light receiving unit 22 has to be adjusted so that the angle deviation is eliminated.

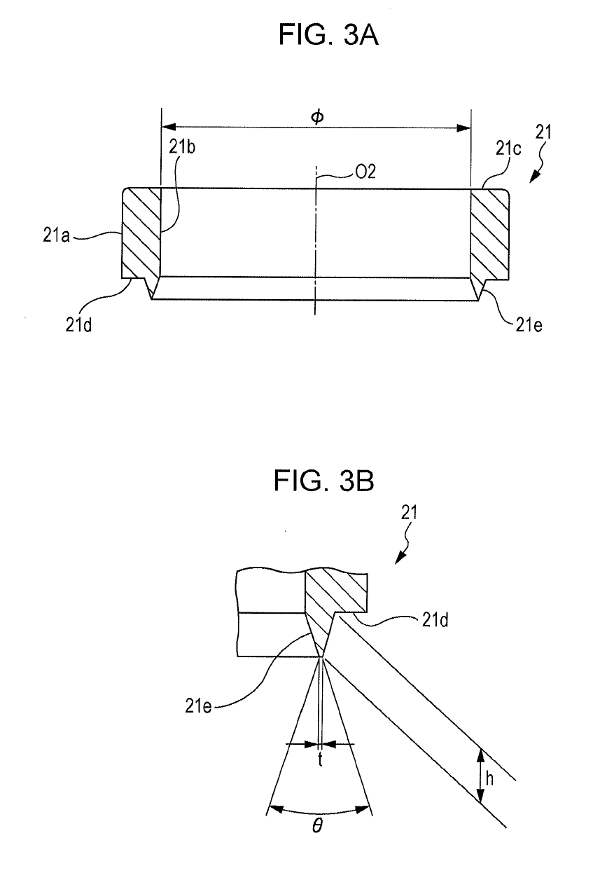

The optical communication device 1 according to the present embodiment includes the first light receiving holder 21 having a structure as illustrated in FIGS. 3A and 3B.

Referring to FIG. 3A, the first light receiving holder 21 has a cylindrical outer face 21a and a through-hole 21b which extends through the thickness of the first light receiving holder 21. The through-hole 21b has a circular cross-section. The center of the through-hole 21b and that of the outer face 21a are positioned on a common center line O2. A portion surrounding one open end of the through-hole 21b serves as an abutting portion 21c to abut against the first light-receiving attachment face 2c of the housing 2. A portion surrounding the other open end thereof serves as a portion (hereinafter, “welded portion”) 21d to be welded to a flange 23a provided for the casing 23 of the first light receiving unit 22. The abutting portion 21c and the welded portion 21d are parallel to each other and are flat faces orthogonal to the center line O2.

As illustrated in FIG. 3A, a projection 21e projects from the welded portion 21d. The projection 21e is continuously provided on the whole circumference (360°) of a circle locus whose center coincides with the center line O2. Referring to FIG. 3B, the projection 21e is tapered such that the cross-sectional area is smaller as the corresponding cross section is farther away from the flat face, serving as the welded portion 21d. In other words, when the projection 21e is cut along a plane including the center line O2, the width of the projection 21e is thinner as the cut plane is farther away from the flat face, serving as the welded portion 21d.

The inner diameter φ of the through-hole 21b of the first light receiving holder 21 is about 4 to about 10 mm. The height, indicated at h, of the projection 21e is in the range of about 0.1 to about 0.6 mm. A portion of the projection 21e to face the flange 23a has an angle θ in the range of about 20 to about 45 degrees. The projection 21e is sharply shaped such that the width t of the tip is equal to or greater than 0.05 mm, preferably, equal to or greater than 0.02 mm.

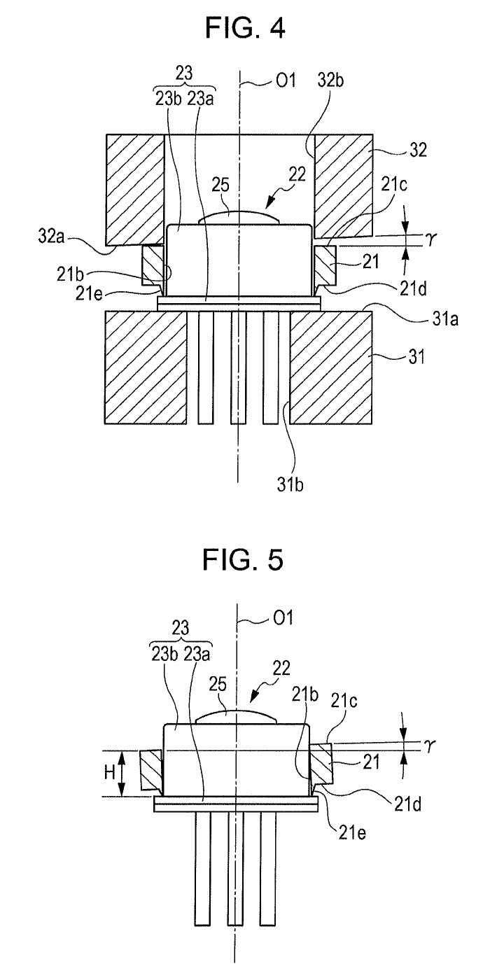

FIG. 4 illustrates a welding operation when the first light receiving unit 22 is fixed to the first light receiving holder 21.

The first light receiving holder 21 is made of a conductive metallic material, such as ferritic stainless steel, capable of being resistance-welded. The casing 23 of the first light receiving unit 22 includes the flange 23a and a cap 23b for receiving the light receiving element 24 and the light receiving lens 25. At least the flange 23a is made of the conductive metallic material, such as ferritic stainless steel, capable of being resistance-welded.

Referring to FIG. 4, resistance welding equipment includes a lower electrode 31 and an upper electrode 32. The upper face of the lower electrode 31 serves as a facing face 31a. The lower electrode 31 has a clearance hole 31b which is positioned in the center of the electrode and vertically extends through the thickness of the electrode. The lower face of the upper electrode 32 serves as a facing face 32a. The upper electrode 32 has a clearance hole 32b which is positioned in the center of the electrode and vertically extends through the thickness of the electrode.

The first light receiving unit 22 is set such that terminals extend through the clearance hole 31b of the lower electrode 31 and the rear face of the flange 23a is in tight contact with the facing face 31a of the lower electrode 31. The cap 23b extends through the through-hole 21b of the first light receiving holder 21 such that the tip of the projection 21e on the first light receiving holder 21 abuts against the front face of the flange 23a. The inner diameter of the through-hole 21b is slightly larger than the outer diameter of the cap 23b, such that the cap 23b can be inclined relative to the center line O2 of the first light receiving holder 21.

The upper end of the cap 23b is received in the clearance hole 32b of the upper electrode 32. The facing face 32a of the upper electrode 32 faces the abutting portion 21c of the first light receiving holder 21. The inner diameter of the clearance hole 32b is slightly larger than the outer diameter of the cap 23b, such that the upper electrode 32 can be inclined relative to the center line O1 of the cap 23b.

In the welding operation, the lower electrode 31 is moved closer to the upper electrode 32, the projection 21e of the first light receiving holder 21 is pressed against the flange 23a of the casing 23, and a voltage is applied between the lower electrode 31 and the upper electrode 32 to supply current to the first light receiving holder 21 and the casing 23. The current is concentrated to the contact between the projection 21e and the flange 23a. The projection 21e is partly melted by Joule heat, thus welding the first light receiving holder 21 to the casing 23.

As illustrated in FIG. 4, a slight angle γ is provided between the facing face 31a of the lower electrode 31 and the facing face 32a of the upper electrode 32. The upper electrode 32 presses the first light receiving holder 21 until the facing face 32a of the upper electrode 32 is brought into tight contact with the abutting portion 21c of the first light receiving holder 21. By this welding operation, the first light receiving holder 21 can be welded to the casing 23 such that the abutting portion 21c of the first light receiving holder 21 is inclined at the angle γ relative to a plane perpendicular to the center line O1 of the casing 23, as illustrated in FIG. 5.

During the welding operation, the distance between the lower electrode 31 and the upper electrode 32 is changed while current is being supplied therebetween, the distance, indicated at H, between the front face of the flange 23a and the abutting portion 21c of the first light receiving holder 21 after welding may be adjusted in the range corresponding to the height h of the projection 21e.

In an operation of assembling the optical communication device 1, as illustrated in FIG. 2, an inclination direction of the first optical path branch L3 set in the housing 2 and the inclination angle β1 thereof are measured. In the first light receiving unit 22, the inclination angle β2 between the center line O1 of the casing 23 and the optical axis L5 and a focal length on the optical axis L5 for forming an image on the light receiving element 24 are measured.

The inclination angle γ of the abutting portion 21c necessary for canceling an angle error is obtained on the basis of the measured inclination angles. In the resistance welding equipment, the angle γ is provided between the facing face 31a of the lower electrode 31 and the facing face 32a of the upper electrode 32.

An optimum value of the distance H between the front face of the flange 23a and the abutting portion 21c is calculated on the basis of the measured focal length. The distance between the facing face 31a and the facing face 32a to be adjusted when the lower electrode 31 is moved close to the upper electrode 32 is set on the basis of the calculated optimum value.

When the first light receiving holder 21 is welded to the first light receiving unit 22 on the basis of the above-described settings, the angle γ of the abutting portion 21c relative to the line perpendicular to the center line O1 of the casing 23 (or the front face of the flange 23a) can be set and the distance H between the front face of the flange 23a and the abutting portion 21c can be set as illustrated in FIG. 5.

So long as the welding operation is performed on the basis of the above-described settings, it is rare that the projection 21e is squashed to be fully melted after the first light receiving holder 21 is welded and fixed to the first light receiving unit 22. In most cases, at least part of the projection 21e retains its original form without being melted such that the unmelted part of the projection 21e remains between the flange 23a and the welded portion 21d of the first light receiving holder 21.

As regards a method of providing the angle γ between the facing face 31a of the lower electrode 31 and the facing face 32a of the upper electrode 32, the lower electrode 31 is fixed in the resistance welding equipment and an adjustment mechanism capable of attaching the upper electrode 32 such that the axis of the upper electrode 32 is slightly inclined is provided. Alternatively, the upper electrode 32 is fixed and an inclination adjustment mechanism is provided for a table on which the lower electrode 31 is mounted. Alternatively, a plurality of upper electrodes 32 having facing faces 32a inclined at different angles γ may be provided and any of the upper electrodes 32 may be selected and used.

Preferably, the projection 21e includes a ring-shaped continuous structure. The projection 21e may include segments successively arranged on a cylinder.

After the first light receiving holder 21 is welded and fixed to the first light receiving unit 22 as illustrated in FIG. 5, the cap 23b of the casing 23 is inserted into the housing 2 and the abutting portion 21c of the first light receiving holder 21 is brought into tight contact with the first light-receiving attachment face 2c of the housing 2 as illustrated in FIG. 1. At this time, the inclination angle γ of the first light receiving unit 22 and the position of the first light receiving unit 22 in a direction along the first optical path branch L3 are determined. The first light receiving holder 21 is finely adjusted in the direction orthogonal to the first optical path branch L3 so that the light receiving element 24 is positioned on a light receiving path on which light travels along the first optical path branch L3. After that, the first light receiving holder 21 is fixed to the housing 2 by, for example, laser welding. Thus, the position of the light receiving element 24 on the first optical path branch L3 and the inclination angle of the element 24 relative to the first optical path branch L3 can be appropriately set.

The second light receiving holder 26 and the second light receiving unit 27 in FIG. 1 can also be adjusted and incorporated in a manner similar to the first light receiving holder 21 and the first light receiving unit 22. When the second light receiving unit 27 receives light modulated based on data having a relatively low density and low transmission rate, only the distance H between the flange and the abutting portion of the second light receiving holder 26 may be adjusted without the inclination angle γ illustrated in FIG. 5 being adjusted.

The optical communication device according to the present embodiment of the present invention is not limited to the wavelength division multiplex type provided with the plurality of light receiving units 22 and 27 as illustrated in FIG. 1. The optical communication device may include only the light receiving unit 22 attached to the housing. Alternatively, the device may be a light-receive-only module that does not include the light emitting unit 18. The optical path may include an optical fiber or may include no optical fiber.

What is claimed is:

1. An optical communication device comprising:
a metal housing:
a casing having a metal flange;
a light receiving element supported by the casing;
a metal holder that fixes the casing to the housing; and
an optical path that guides light to the light receiving element, wherein
the holder has a through-hole, an abutting portion surrounding one open end of the through-hole, and a welded portion surrounding the other open end of the through-hole, the welded portion including a projection whose cross-sectional area is smaller as the corresponding cross-section is closer to the tip of the projection,
the holder and the flange are welded to each other through the partly melted projection pressed against the flange such that unmelted part of the projection adjusts an inclination angle of the abutting portion of the holder relative to the center line of the casing, and
the holder is fixed to the housing such that the abutting portion is in contact with the housing and an angle at which the light receiving element faces the optical path is determined on the basis of the inclination angle.

2. The device according to claim 1, wherein the distance between the flange and the abutting portion of the holder is determined on the basis of the height of the melted projection to set the distance between the light receiving element and the optical path.

3. The device according to claim 1, wherein in the welded portion, the projection includes a continuous structure arranged about the center line.

4. The device according to claim 1, wherein in the welded portion, the projection includes segments successively arranged about the center line.

5. A method of assembling an optical communication device including a metal housing, a casing having a metal flange, a light receiving element supported by the casing, a metal holder that fixes the casing to the housing, and an optical path that guides light to the light receiving element, the holder having a through-hole, an abutting portion surrounding one open end of the through-hole, and a welded portion surrounding the other open end of the through-hole, the welded portion including a projection whose cross-sectional area is smaller as the corresponding cross-section is closer to the tip of the projection, the method comprising the steps of:
(a) while pressing the projection against the flange, supplying current to the holder and the flange to melt the projection in order to weld the holder to the flange;
(b) adjusting an inclination angle of the holder relative to the flange during welding; and
(c) bringing the abutting portion into contact with the housing to fix the holder to the housing such that an angle at which the light receiving element faces the optical path is set on the basis of the inclination angle.

6. The method according to claim 5, wherein the step (b) includes the substeps of:
determining the distance between the flange and the abutting portion of the holder on the basis of the height of the melted projection; and
setting the distance between the light receiving element and the optical path.

7. The method according to claim 5, wherein the step (c) includes the substeps of:
bringing the abutting portion of the holder into contact with the housing;
moving and adjusting the holder in a direction orthogonal to the center line; and
fixing the holder to the housing.

8. The method according to claim 5, wherein the projection includes a continuous structure arranged about the center line.

9. The method according to claim 5, wherein the projection includes segments successively arranged about the center line.
